(19) United States
(12) Patent Application Publication
(10) Pub. No.: US 2024/0120582 A1
(43) Pub. Date: Apr. 11, 2024

(54) BATTERY

(71) Applicant: Panasonic Intellectual Property Management Co., Ltd., Osaka (JP)

(72) Inventor: KENTA NAGAMINE, Osaka (JP)

(21) Appl. No.: 18/542,600

(22) Filed: Dec. 16, 2023

Related U.S. Application Data
(63) Continuation of application No. PCT/JP2022/026076, filed on Jun. 29, 2022.

(30) Foreign Application Priority Data
Jul. 9, 2021 (JP) 2021-114611

(51) Int. Cl. H01M 50/121; H01M 10/0562; H01M 50/119; H01M 50/124; H01M 50/129

(52) U.S. Cl. CPC H01M 50/121; H01M 10/0562; H01M 50/119; H01M 50/1243; H01M 50/129; H01M 2300/008

(57) ABSTRACT

A battery includes a power generator, and a covering material that covers the power generator, in which the power generator includes a positive electrode layer, a negative electrode layer, and a solid electrolyte layer positioned between the positive electrode layer and the negative electrode layer, at least one selected from the group consisting of the positive electrode layer, the solid electrolyte layer, and the negative electrode layer contains a solid electrolyte containing halogen, the covering material includes a base layer, a resin layer, and an interlayer positioned between the base layer and the resin layer, and the resin layer is disposed on a side facing the power generator and contains a halogen-containing polymer.

### BACKGROUND

### 1. Technical Field

The present disclosure relates to a battery.

### 2. Description of the Related Art

Japanese Unexamined Patent Application Publication No. 2012-164680 discloses a laminate containing aluminum, as a covering material for a battery. Japanese Unexamined Patent Application Publication No. 2012-164680 discloses that hydrogen fluoride generated by decomposition of lithium hexafluorophosphate, which is a lithium salt used in a non-aqueous electrolyte secondary battery, corrodes aluminum serving as a protective layer of the covering material and causes delamination of the covering material. In addition, a method of inserting an interlayer between a protective layer and an adhesive layer is disclosed as a method of preventing such delamination.

### SUMMARY

One non-limiting and exemplary embodiment provides a technique of improving the reliability of a battery.

In one general aspect, the techniques disclosed here feature a battery including a power generator, and a covering material that covers the power generator, in which the power generator includes a positive electrode layer, a negative electrode layer, and a solid electrolyte layer positioned between the positive electrode layer and the negative electrode layer, at least one selected from the group consisting of the positive electrode layer, the solid electrolyte layer, and the negative electrode layer contains a solid electrolyte containing halogen, the covering material includes a base layer, a resin layer, and an interlayer positioned between the base layer and the resin layer, and the resin layer is disposed on a side facing the power generator and contains a halogen-containing polymer.

According to the present disclosure, it is possible to improve the reliability of the battery.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A is a view showing a schematic configuration of a covering material according to Embodiment 1;

FIG. 1B is a view showing a schematic configuration of a covering material according to Embodiment 2;

FIG. 2 is a view showing a schematic configuration of a battery according to Embodiment 1;

FIG. 3A is a view showing a schematic configuration of a covering material according to Embodiment 3;

FIG. 3B is a view showing a schematic configuration of a covering material according to Embodiment 4;

FIG. 4A is a view showing a schematic configuration of a covering material according to Embodiment 5;

FIG. 4B is a view showing a schematic configuration of a covering material according to Embodiment 6;

FIG. 5A is a view showing a schematic configuration of a covering material according to Embodiment 7;

FIG. 5B is a view showing a schematic configuration of the covering material according to Embodiment 7; and

FIG. 6 is a cross-sectional view showing a schematic configuration of an example of a power generation device.

### DETAILED DESCRIPTIONS

### Underlying Knowledge Forming Basis of the Present Disclosure

In a non-aqueous electrolyte secondary battery such as a lithium ion secondary battery, the potential of a positive electrode during the charging reaction of the battery increases to a high potential exceeding 4 V with respect to lithium. Studies by the present inventor have found a phenomenon in which when a halogen-containing solid electrolyte is used as a component material of a solid battery, and charging is performed up to such a high potential, the halogen present in the solid electrolyte as anions is oxidized to be discharged as a halogen gas or a hydrogen halide gas. Such gas has high corrosiveness and easily reacts with a metal or an organic material.

Meanwhile, a laminate prepared by laminating various materials has been widely used as a covering material for a battery. Such a laminate is mainly formed of a base layer for maintaining the shape, a protective layer for preventing entrance of moisture or oxygen, and an adhesive layer for thermally welding laminates in a case where a plurality of laminates are laminated. Nylon, aluminum, and a polyolefin resin are used as the base layer, the protective layer, and the adhesive layer, respectively.

Japanese Unexamined Patent Application Publication No. 2012-164680 discloses generation of hydrogen fluoride due to decomposition of a lithium salt in an electrolyte solution causes corrosion of a material in the laminate. Also disclosed is, as a measure against the phenomenon, disposing an intermediate layer for suppressing corrosion by hydrofluoric acid between the protective layer and the adhesive layer. Japanese Unexamined Patent Application Publication No. 2012-164680 also discloses providing a protective layer formed of resin such as an epoxy resin on the surface of the innermost layer side of a barrier layer to absorb and/or adsorb hydrogen fluoride.

However, although the configuration disclosed in Japanese Unexamined Patent Application Publication No. 2012-164680 suppresses the corrosion of aluminum in the protective layer to be able to protect the delamination of the adhesive layer, studies by the present inventor have found a problem in that the corrosion of the adhesive layer itself cannot be suppressed.

The corrosive gas generated in a solid-state battery remains as gas inside a container formed of a laminate at a high concentration and thus reacts with a polyolefin resin serving as an adhesive layer, and accordingly, the flexibility of the adhesive layer is significantly decreased. When the reaction progresses, the protective layer inside the laminate is corroded by the corrosive gas and destroyed simultaneously with destruction of the adhesive layer. Consequently, the laminate cannot maintain the insulating properties or the gas barrier properties as the covering material of the battery, and thus the reliability of the battery cannot be ensured.

The present disclosure has been made in view of the above-described problem, and an object thereof is to improve the reliability of the battery.

### Summary of Aspects of the Present Disclosure

According to a first aspect of the present disclosure, there is provided a battery including:
a power generator; and a covering material that covers the power generator, in which
the power generator includes
a positive electrode layer,
a negative electrode layer, and
a solid electrolyte layer positioned between the positive electrode layer and the negative electrode layer,
at least one selected from the group consisting of the positive electrode layer, the solid electrolyte layer, and the negative electrode layer contains a solid electrolyte containing halogen,
the covering material includes
a base layer,
a resin layer, and
an interlayer positioned between the base layer and the resin layer, and
the resin layer is disposed on a side facing the power generator and contains a halogen-containing polymer.

According to the first aspect, direct contact between the corrosive gas and the layer of the covering material having insulating properties or gas barrier properties can be prevented. Therefore, the reliability of the battery can be improved.

In a second aspect of the present disclosure, for example, in the battery according to the first aspect, the covering material may further include a metal layer positioned between the base layer and the interlayer.

In a third aspect of the present disclosure, for example, in the battery according to the second aspect, the metal layer may contain at least one selected from the group consisting of aluminum, an aluminum alloy, and stainless steel.

In a fourth aspect of the present disclosure, for example, in the battery according to the second aspect, the metal layer may contain aluminum.

In a fifth aspect of the present disclosure, for example, in the battery according to any one of the first to fourth aspects, an ionic radius of halogen contained in the resin layer may be the same as or less than an ionic radius of the halogen contained in the solid electrolyte.

In a sixth aspect of the present disclosure, for example, in the battery according to any one of the first to fifth aspects, the resin layer may have a thickness less than a thickness of the interlayer.

In a seventh aspect of the present disclosure, for example, in the battery according to any one of the first to sixth aspects, the resin layer may have a variation in thickness depending on a site.

In an eighth aspect of the present disclosure, for example, in the battery according to any one of the first to sixth aspects, the covering material may include a first covering material and a second covering material, the resin layer may include a first resin layer and a second resin layer, the interlayer may include a first interlayer and a second interlayer, and a portion where the first covering material and the second covering material face each other may include a portion where the first interlayer and the second interlayer are in contact with each other.

In a ninth aspect of the present disclosure, for example, in the battery according to any one of the first to eighth aspects, the interlayer may contain a filler and another material other than the filler, and the filler may include a filler having a softening point higher than a softening point of the other material.

In a tenth aspect of the present disclosure, for example, in the battery according to the ninth aspect, the filler may have a melting point higher than a melting point of the halogen-containing polymer.

In an eleventh aspect of the present disclosure, for example, in the battery according to any one of the first to tenth aspects, the resin layer may have a pore.

In a twelfth aspect of the present disclosure, for example, in the battery according to any one of the first to eleventh aspects, the halogen-containing polymer may be a polymer containing a fluorine atom or a chlorine atom.

In a thirteenth aspect of the present disclosure, for example, in the battery according to the twelfth aspect, the halogen-containing polymer may be a polymer containing fluorine, and the polymer containing fluorine may contain at least one selected from the group consisting of tetrafluoroethylene, vinylidene fluoride, perfluoroalkyl vinyl ether, hexafluoropropylene, chlorotrifluoroethylene, and copolymers thereof.

In a fourteenth aspect of the present disclosure, for example, in the battery according to the twelfth aspect, the halogen-containing polymer may be a polymer containing fluorine, and the polymer containing fluorine may contain at least one selected from the group consisting of tetrafluoroethylene, vinylidene fluoride, hexafluoropropylene, and copolymers thereof.

In a fifteenth aspect of the present disclosure, for example, in the battery according to the twelfth aspect, the halogen-containing polymer may be a polymer containing fluorine, and the polymer containing fluorine may contain at least one selected from the group consisting of polyethylene fluoride, polypropylene fluoride, a tetrafluoroethylene-hexafluoropropylene copolymer, polytetrafluoroethylene, polyvinylidene fluoride, polyvinyl fluoride, polychlorotrifluoroethylene, fluororubber, fluorosilicone rubber, a vinylidene fluoride-hexafluoropropylene copolymer, a vinylidene fluoride-hexafluoropropylene-tetrafluoroethylene copolymer, tetrafluoroethylene-propylene rubber, and tetrafluoroethylene-perfluoromethyl vinyl ether rubber.

In a sixteenth aspect of the present disclosure, for example, in the battery according to any one of the first to fifteenth aspects, a concentration of halogen of the resin layer may increase continuously or stepwisely from a side facing the interlayer to a side facing away from the interlayer.

According to the second to sixteenth aspects, direct contact between the corrosive gas and the layer of the covering material having insulating properties or gas barrier properties can be prevented. Therefore, the reliability of the battery can be improved.

According to a seventeenth aspect of the present disclosure, there is provided a covering material for a battery, including:
a base layer;
a resin layer; and
an interlayer positioned between the base layer and the resin layer, in which the resin layer contains a halogen-containing polymer.

In an eighteenth aspect of the present disclosure, for example, the covering material for a battery according to the seventeenth aspect may further include a metal layer positioned between the base layer and the interlayer.

In a nineteenth aspect of the present disclosure, for example, in the covering material for a battery according to the eighteenth aspect, the metal layer may contain aluminum.

In a twentieth aspect of the present disclosure, for example, in the covering material for a battery according to any one of the seventeenth to nineteenth aspects, the halogen-containing polymer may be a polymer containing a fluorine atom or a chlorine atom.

In a twenty-first aspect of the present disclosure, for example, in the covering material for a battery according to the twentieth aspect, the halogen-containing polymer may be a polymer containing fluorine, and the polymer containing fluorine may contain at least one selected from the group consisting of tetrafluoroethylene, vinylidene fluoride, perfluoroalkyl vinyl ether, hexafluoropropylene, and chlorotrifluoroethylene.

In a twenty-second aspect of the present disclosure, for example, in the covering material for a battery according to the twentieth aspect, the halogen-containing polymer may be a polymer containing fluorine, and the polymer containing fluorine may contain at least one selected from the group consisting of tetrafluoroethylene, vinylidene fluoride, and hexafluoropropylene.

In a twenty-third aspect of the present disclosure, for example, in the covering material for a battery according to the twentieth aspect, the halogen-containing polymer may be a polymer containing fluorine, and the polymer containing fluorine may contain at least one selected from the group consisting of polyethylene fluoride, polypropylene fluoride, a tetrafluoroethylene-hexafluoropropylene copolymer, polytetrafluoroethylene, polyvinylidene fluoride, polyvinyl fluoride, polychlorotrifluoroethylene, fluorosilicone rubber, a vinylidene fluoride-hexafluoropropylene copolymer, a vinylidene fluoride-hexafluoropropylene-tetrafluoroethylene copolymer, tetrafluoroethylene-propylene rubber, and tetrafluoroethylene-perfluoromethyl vinyl ether rubber.

According to the sixteenth to twenty-third aspects, when the covering material is applied to the battery, direct contact between the corrosive gas inside the battery and the layer of the covering material having insulating properties or gas barrier properties can be prevented. Therefore, the covering material according to the present disclosure can improve the reliability of the battery.

Hereinafter, embodiments of the present disclosure will be described with reference to the accompanying drawings. The present disclosure is not limited to the following embodiments.

### Embodiments

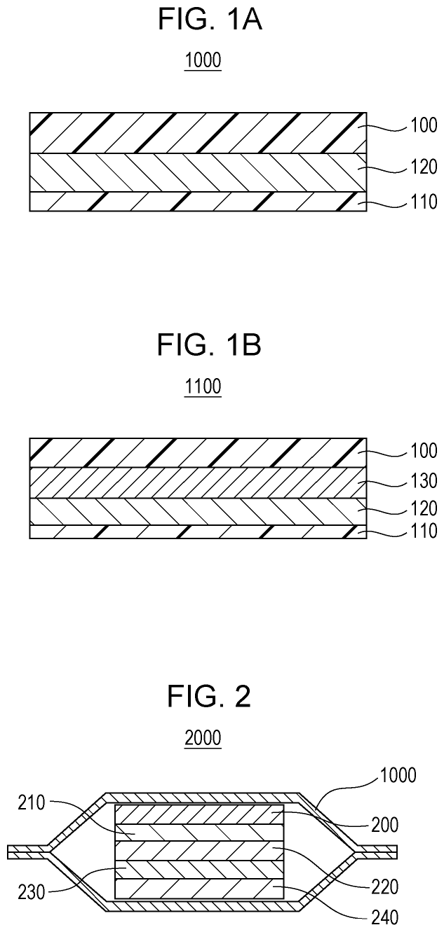

FIG. 1A is a cross-sectional view showing a schematic configuration of a covering material 1000 in Embodiment 1.

The covering material 1000 in Embodiment 1 includes a base layer 100, a resin layer 110, and an interlayer 120 positioned between the base layer 100 and the resin layer 110. The resin layer 110 contains a halogen-containing polymer. The resin layer 110 is positioned on a side facing the power generator of the battery. The resin layer 110 is a layer containing a resin. The resin layer 110 contains a halogen-containing polymer.

The material of the base layer 100 may be a polyester resin, a nylon resin, or the like. The material such as a polyester resin or a nylon resin may be stretched. The polyester resin may be polyethylene terephthalate, polybutylene terephthalate, polyethylene naphthalate, polybutylene naphthalate, copolyester, polycarbonate, or the like. The nylon resin may be Nylon 6, Nylon 6,6, a copolymer of Nylon 6,6 and Nylon 6, Nylon 6,10, or a polyimide resin such as poly(m-xylylene adipamide) (MXD6). The thickness of the base layer 100 may be greater than or equal to 5 μm and less than or equal to 40 μm.

The halogen-containing polymer contains a halogen atom in the structure. The halogen atom contained in the halogen-containing polymer may be a fluorine atom, a chlorine atom, a bromine atom, an iodine atom, or the like. The halogen-containing polymer contained in the resin layer 110 may be a polymer containing a fluorine atom or a chlorine atom. The ionic radius of the halogen contained in the resin layer 110 may be the same as or less than the ionic radius of the halogen contained in the solid electrolyte.

According to the configuration described above, erosion of the interlayer 120 due to the corrosive gas can be more effectively suppressed. As the ionic radius of the halide ion decreases, the electronegativity increases, and the halide ion is strongly bonded to carbon in a polymer chain. That is, when the ionic radius of the halide ion contained in the resin layer 110 is less than the ionic radius of the halide ion contained in the generated corrosive gas, the halide ion in the corrosive gas is unlikely to react with the polymer of the resin layer 110. Further, even when the ionic radii are the same as each other, that is, the elements are the same as each other, since the driving force of the reaction is small, the reaction is unlikely to occur.

The interlayer 120 may contain a metal or a resin. The resin contained in the interlayer 120 may be a thermoplastic resin, a thermosetting resin, or a cyanoacrylate resin. The thermoplastic resin may be, for example, a polyolefin resin, an acrylic resin, a polystyrene resin, a vinyl chloride resin, a silicone resin, a polyamide resin, a polyimide resin, a fluorinated hydrocarbon resin, a polyether resin, or rubber. The polyolefin resin may be a polyethylene resin, a polypropylene resin, or the like. The rubber may be butadiene rubber, isoprene rubber, styrene-butadiene rubber (SBR), a styrene-butadiene-styrene copolymer (SBS), a styrene-ethylene-butadiene-styrene copolymer (SEBS), ethylene-propylene rubber, butyl rubber, chloroprene rubber, acrylonitrile-butadiene rubber, or the like. The thermosetting resin may be a urethane resin, an epoxy resin, or the like. The resin may be used alone or in combination of two or more kinds thereof. The thickness of the resin layer 110 may be less than the thickness of the interlayer 120. According to the configuration described above, both the resistance to the corrosive gas and the adhesiveness of the covering material 1000 can be achieved. The halogen-containing polymer in the structure of the covering material 1000 has a softening point that increases, and thus a harder material is formed at room temperature as compared with a case where a polymer containing no halogen is used. Therefore, in a case where the resin layer 110 is present inward than the interlayer 120, that is, present on the side facing the power generator of the battery, adhesion of the covering materials 1000 is disturbed when a plurality of the covering materials 1000 are laminated. When the thickness of the resin layer 110 is less than the thickness of the interlayer 120, since only the portion of the resin layer 110 that has been heated and pressure-bonded in a case of welding (constituting the container of the battery in FIG. 2 using the covering material 1000) the covering material 1000 is broken and the interlayers 120 inside the laminate adhere to each other, the adhesiveness can be ensured. Meanwhile, in a portion that has not been pressure-bonded, the resin layer 110 is present on the innermost surface, corrosion due to halogen gas can be suppressed. In the resin layer 110, the concentration of halogen may increase continuously or stepwisely from the side facing the interlayer 120 to the side facing away from the interlayer 120. The concentration of halogen denotes the amount of the halogen element contained in the resin layer 110. A method of measuring the amount of the halogen element may be performed by elemental analysis from the surface direction to the depth direction using a glow discharge emission spectrometer.

FIG. 1B is a cross-sectional view showing a schematic configuration of a covering material 1100 in Embodiment 2. A container similar to that of the battery in FIG. 2 (Embodiment 1) can be formed by using the covering material 1100.

The covering material 1100 in Embodiment 2 includes the base layer 100, the resin layer 110, the interlayer 120 positioned between the base layer 100 and the resin layer 110, and a metal layer 130 positioned between the base layer 100 and the interlayer 120. The resin layer 110 contains a halogen-containing polymer. The metal layer 130 is a layer containing a metal. The covering material 1100 in Embodiment 2 is different from the covering material 1000 in Embodiment 1 in that the covering material 1100 includes the metal layer 130, but other layers may be same as the layers of the covering material 1000 in Embodiment 1.

The metal layer 130 may contain at least one metal element selected from the group consisting of aluminum and iron. The metal layer 130 may contain at least one selected from aluminum, an aluminum alloy, and stainless steel. The aluminum alloy may be an alloy containing aluminum as a main component. The metal layer 130 may contain aluminum. According to the configuration described above, the covering material 1100 of the battery can achieve sufficient strength, lightness, and economic efficiency. The thickness of the metal layer 130 may be greater than or equal to 5 μm and less than or equal to 80 μm. The metal layer 130 is typically formed of metal foil.

FIG. 2 is a view showing a schematic configuration of a battery 2000 in Embodiment 1.

The battery 2000 in Embodiment 1 includes the covering material 1000, a positive electrode current collector 200, a positive electrode layer 210, a solid electrolyte layer 220, a negative electrode layer 230, and a negative electrode current collector 240. The solid electrolyte layer 220 is disposed between the positive electrode layer 210 and the negative electrode layer 230. The positive electrode layer 210 is a layer containing a positive electrode active material. The negative electrode layer 230 is a layer containing a negative electrode active material. The positive electrode layer 210, the solid electrolyte layer 220, and the negative electrode layer 230 constitute the power generator of the battery 2000. At least one of the positive electrode layer 210, the solid electrolyte layer 220, or the negative electrode layer 230 contains a solid electrolyte containing halogen. The solid electrolyte containing halogen may be a halide solid electrolyte or a sulfide solid electrolyte containing halogen. The positive electrode current collector 200 and the negative electrode current collector 240 are electrically connected with the positive electrode layer 210 and the negative electrode layer 230, respectively. The covering material 1000 constitutes the container of the battery 2000. Specifically, the resin layer 110 of the upper covering material 1000 and the resin layer 110 of the lower covering material 1000 of FIG. 2 are oriented to face each other at end portions and heated and pressure-bonded to constitute the container of the battery 2000. Here, at least a part of the resin layer 110 is broken so that the interlayer 120 of the upper covering material 1000 and the interlayer 120 of the lower covering material 1000 of FIG. 2 adhere to each other. The power generator of the battery 2000 is accommodated in the container formed of the covering material 1000. In this manner, the power generator of the battery 2000 is covered with the covering material 1000.

According to the configuration described above, a battery with high reliability can be realized. Since the contact between the corrosive gas generated when the battery is charged and the interlayer 120 can be reduced by disposing the resin layer 110 on a side facing the power generator, deterioration of the interlayer 120 can be suppressed. In the present embodiment, the resin layer 110 is in contact with the atmosphere inside the container formed of the covering material 1000.

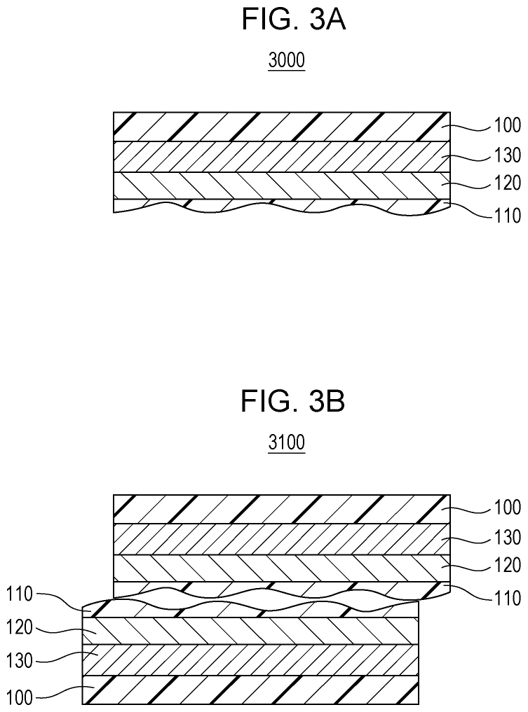

FIG. 3A is a view showing a schematic configuration of a covering material 3000 in Embodiment 3.

The resin layer 110 may have a variation in thickness depending on the site. According to the configuration described above, both the resistance to the corrosive gas and the adhesiveness of the covering material 3000 can be achieved. In a case where the resin layer 110 has a variation in thickness, when the resin layers 110 of the covering materials 3000 are oriented to face each other and heated and pressure-bonded to each other, thick portions of the resin layers 110 come into contact with each other and are pressed, and thus thin portions of the resin layers 110 are broken. In this manner, when a container similar to that of the battery in FIG. 2 is formed by using the covering material 3000, the interlayers 120 can be exposed and thus can easily adhere to each other. Since the breakage of the resin layers 110 occurs only in portions that have been heated and pressure-bonded, deterioration of the broken portions due to halogen gas does not occur. The shape of the cross section of the resin layer 110 generated due to the variation in thickness may be a sinusoidal shape, a rectangular wave shape, a triangular wave shape, or a random shape. The covering material 3000 in Embodiment 3 is different from the covering materials 1000 and 1100 in Embodiments 1 and 2 in that the resin layer 110 has a variation in thickness depending on the site, but other layers may be the same as the layers of the covering materials 1000 and 1100 in Embodiments 1 and 2.

FIG. 3B is a view showing a schematic configuration of a covering material 3100 in Embodiment 4. The covering material 3100 is a laminate in which the resin layers 110 of two covering materials 3000 are laminated to face each other. As in the covering material 3000 shown in FIG. 3A and the covering material 3100 shown in FIG. 3B, the resin layer 110 may have a variation in thickness. According to the configuration described above, both the resistance to the corrosive gas and the adhesiveness of the covering material 3000 can be achieved. The resin layer 110 may have a variation in thickness. In a case where the resin layer 110 has a variation in thickness, when the resin layers 110 of the covering materials 3100 are oriented to face each other and heated and pressure-bonded to each other, thick portions of the resin layers 110 come into contact with each other and are pressed, and thus thin portions of the resin layers 110 are broken. In this manner, when a container similar to that of the battery in FIG. 2 is formed by using the covering material 3100, the interlayers 120 can be exposed and thus can easily adhere to each other. Since the breakage of the resin layers 110 occurs only in portions that have been heated and pressure-bonded, deterioration of the broken portions due to halogen gas does not occur. In a case where the resin layer 110 has a variation in thickness depending on the site, the thickness of the resin layer 110 may be less than the thickness of the interlayer 120 even when the thickest portion of the resin layer 110 is compared with the thickness of the interlayer 120. The thickness of the resin layer 110 may be greater than or equal to 1 μm and less than or equal to 50 μm. The covering material 3100 in Embodiment 4 is different from the covering materials 1000 and 1100 in Embodiments 1 and 2 in that the resin layer 110 has a variation in thickness depending on the site. In addition, other layers may be the same as the layers of the covering materials 1000 and 1100 in Embodiments 1 and 2.

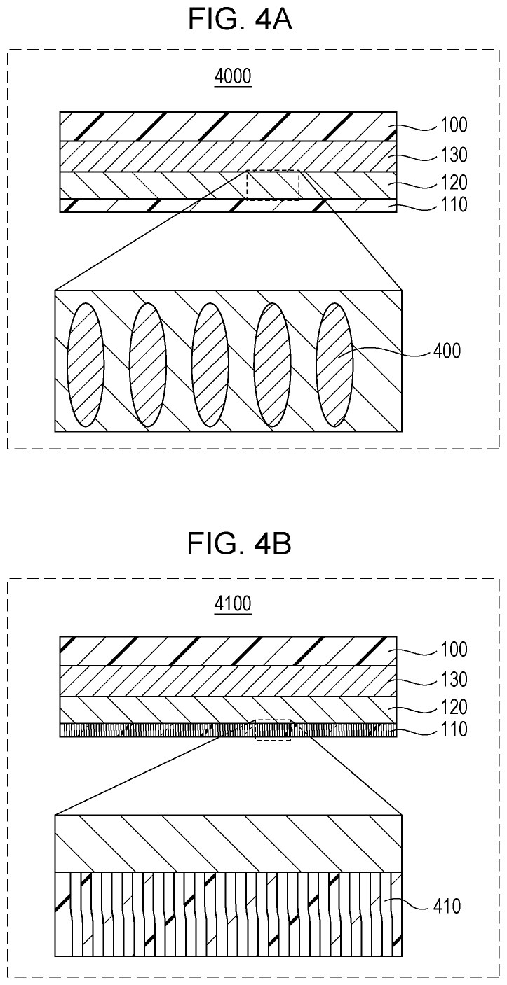

FIG. 4A is a view showing a schematic configuration of a covering material 4000 in Embodiment 5.

As shown in FIG. 4A, the interlayer 120 may contain a filler and other materials in addition to the filler. The filler may include a filler 400 having a softening point higher than the softening points of the other materials. The other materials in addition to the filler may be a resin. The resin may be a thermoplastic resin, a thermosetting resin, or a cyanoacrylate resin. The thermoplastic resin may be, for example, a polyolefin resin, an acrylic resin, a polystyrene resin, a vinyl chloride resin, a silicone resin, a polyimide resin, a polyimide resin, a fluorinated hydrocarbon resin, a polyether resin, or rubber. The polyolefin resin may be a polyethylene resin, a polypropylene resin, or the like. The rubber may be butadiene rubber, isoprene rubber, styrene-butadiene rubber (SBR), a styrene-butadiene-styrene copolymer (SBS), a styrene-ethylene-butadiene-styrene copolymer (SEBS), ethylene-propylene rubber, butyl rubber, chloroprene rubber, acrylonitrile-butadiene rubber, or the like. The thermosetting resin may be a urethane resin, an epoxy resin, or the like. The resin may be used alone or in combination of two or more kinds thereof. The thickness of the interlayer 120 may be greater than or equal to 5 μm and less than or equal to 100 μm. According to the configuration described above, both the resistance to the corrosive gas and the adhesiveness of the covering material 4000 can be achieved. When the innermost layer is formed of a halogen-containing polymer having a high softening point, adhesion of the covering materials 4000 is required to be made at a high temperature in a case where a plurality of the covering materials 4000 are laminated. In this manner, the interlayer 120 having a low softening point is crushed earlier than the innermost layer and pushed out from the pressurized portion, and thus the covering material may be extremely thin or the interlayer 120 may disappear. Therefore, when the filler 400 having a high softening point is introduced into the interlayer 120, the structure of the interlayer 120 is maintained, and thus the adhesiveness can be maintained. The shape of the filler 400 may be a spherical shape, an elliptical shape, a conical shape, a disk shape, a columnar shape, an amorphous shape, or a cubic shape. The material of the filler 400 may be a polymer, a ceramic material, or a carbon material. The filler may be oxide glass, aluminum oxide, aluminum oxyhydroxide, zirconium oxide, titanium oxide, magnesium oxide, calcium oxide, or the like.

The softening point of the filler 400 is higher than the softening points of other materials in addition to the filler used in the resin layer 110. According to the configuration described above, both the resistance to the corrosive gas and the adhesiveness of the covering material 4000 can be achieved. Since the softening point of the filler 400 is higher than the softening point of the resin layer 110, the structure of the filler 400 is maintained and thus breakage of the resin layer 110 can be promoted when the interlayer 120 and the resin layer 110 are crushed by being heated and pressure-bonded (when a container similar to that of the battery in FIG. 2 is formed by using the covering material 4000). In this manner, the interlayers 120 are exposed from the broken portions, and the covering materials 4000 can adhere to each other when a plurality of the covering materials 4000 are laminated.

The melting point of the filler 400 may be higher than the melting point of the halogen-containing polymer. According to the configuration described above, both the resistance to the corrosive gas and the adhesiveness of the covering material 4000 can be achieved. Since the melting point of the filler 400 is higher than the melting point of the halogen-containing polymer, the structure of the filler 400 is maintained and thus breakage of the resin layer 110 can be promoted when the interlayer 120 and the resin layer 110 are crushed by being heated and pressure-bonded. In this manner, the interlayers 120 are exposed from the broken portions, and the covering materials 4000 can adhere to each other when a plurality of the covering materials 4000 are laminated. The covering material 4000 in Embodiment 5 is different from the covering materials in Embodiments 1 to 4 in that the interlayer 120 contains a filler and other materials in addition to the filler, but other layers may be the same as the layers of the covering materials in Embodiments 1 to 4.

FIG. 4B is a view showing a schematic configuration of a covering material 4100 in Embodiment 6. As shown in FIG. 4B, the resin layer 110 has pores 410. According to the configuration described above, the adhesiveness of the covering material 4000 can be exhibited. Since the resin layer 110 has pores, the interlayer 120 is exposed from the pores when the layers are heated and pressure-bonded (when a container similar to that of the battery in FIG. 2 is formed by using the covering material 4100) so that the covering materials 4000 can adhere to each other in a case where a plurality of the covering materials 4000 are laminated. The pores may be straight pores or curved pores. The pores may be straight pores extending in the thickness direction. The pores may have a diameter of greater than or equal to 1 nm and less than or equal to 10 μm in terms of the equivalent circle diameter. The pores may communicate with each other. The pores may be included in the resin layer 110 as a three-dimensional structure. The covering material 4100 in Embodiment 6 is different from the covering materials in Embodiments 1 to 5 in that the resin layer 110 has the pores 410, but other layers may be the same as the layers of the covering materials in Embodiments 1 to 5.

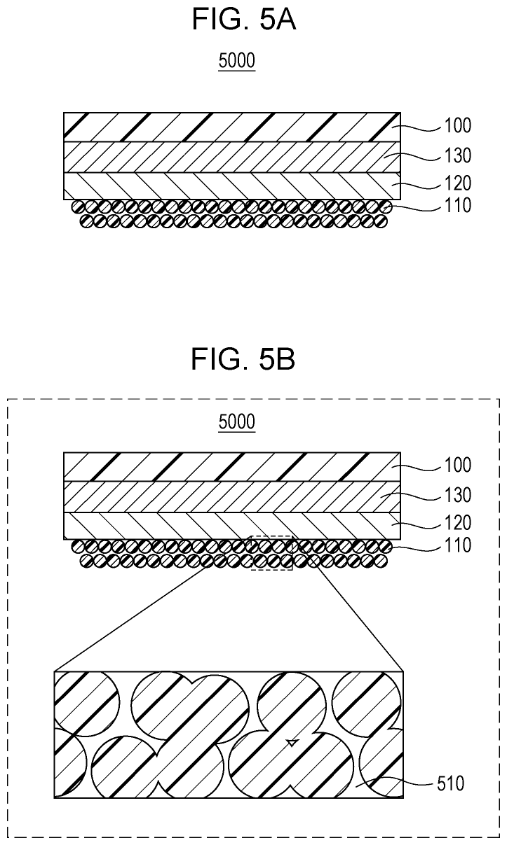

FIG. 5A is a view showing a schematic configuration of a covering material 5000 in Embodiment 7.

As shown in FIG. 5A, the resin layer 110 may be formed by laminating fine particles. According to the configuration described above, the adhesiveness of the covering material 5000 can be exhibited.

FIG. 5B is a view showing a schematic configuration of a covering material 5000 in Embodiment 7. When the resin layer 110 is formed of fine particles, pores 510 are generated in the resin layer 110. The interlayer 120 is exposed from the pores 510 when the layers are heated and pressure-bonded (when a container similar to that of the battery in FIG. 2 is formed by using the covering material 5000) so that the covering materials 5000 can adhere to each other in a case where a plurality of the covering materials 5000 are laminated. Further, the layer that are not specifically described may be the same as the layers of the covering materials in Embodiments 1 to 6.

Hereinafter, a specific example of the resin layer 110 of the covering materials in Embodiments 1 to 7 will be described. The resin layer 110 contains a halogen-containing polymer. The halogen-containing polymer may be a polymer resin containing a fluorine atom or a chlorine atom. According to the configuration described above, the resistance to the corrosive gas can be realized.

The polymer containing fluorine may contain at least one selected from the group consisting of tetrafluoroethylene (TFE), vinylidene fluoride, perfluoroalkyl vinyl ether, hexafluoropropylene (HFP), and chlorotrifluoroethylene. According to the configuration described above, both the resistance to the corrosive gas and the formability can be achieved.

Further, the polymer containing fluorine may contain at least one selected from the group consisting of tetrafluoroethylene, vinylidene fluoride, and hexafluoropropylene. According to the configuration described above, both the resistance to the corrosive gas and the formability can be achieved.

The polymer containing fluorine may contain fluororubber. The fluororubber may be fluorosilicone rubber, a vinylidene fluoride-hexafluoropropylene copolymer (FKM), a vinylidene fluoride-hexafluoropropylene-tetrafluoroethylene copolymer, tetrafluoroethylene-propylene rubber (FEPM), tetrafluoroethylene-perfluoromethyl vinyl ether rubber (FFKM), or the like. The polymer containing fluorine may contain at least one selected from the group consisting of polyethylene fluoride, polypropylene fluoride, a tetrafluoroethylene-hexafluoropropylene copolymer (FEP), polytetrafluoroethylene (PTFE), polyvinylidene fluoride (PVDF), polyvinyl fluoride (PVF), polychlorotrifluoroethylene (PCTFE), fluororubber, fluorosilicone rubber, a vinylidene fluoride-hexafluoropropylene copolymer, a vinylidene fluoride-hexafluoropropylene-tetrafluoroethylene copolymer, tetrafluoroethylene-propylene rubber (FEPM), and tetrafluoroethylene-perfluoromethyl vinyl ether rubber (FFKM). According to the configuration described above, the resistance to the corrosive gas can be realized.

The resin layer 110 is formed by modifying the surface of the interlayer 120. According to the configuration described above, both the resistance to the corrosive gas and the formability can be achieved. In the preparation of the covering material 5000, the resin layer 110 may be formed by brining halogen-containing gas such as fluorine gas, hydrogen fluoride gas, chlorine gas, or hydrogen chloride gas into contact with the surface of the covering material 5000 and introducing fluorine or chlorine into the polymer in the surface of the interlayer 120. The surface of the interlayer 120 may be modified by immersing the covering material 5000 in a solution containing at least one selected from the group consisting of a fluoride ion and a chloride ion.

The concentration of the halogen in the resin layer 110 increases continuously or stepwisely from the side facing the interlayer 120 to the side facing away from the interlayer 120. According to the configuration described above, both the resistance to the corrosive gas and the formability can be achieved. The thickness of the resin layer 110 may be greater than or equal to 1 nm and less than or equal to 10000 nm.

Hereinafter, a specific example of a power generation device 6000 in a case of forming a battery that contains a covering material selected from the group consisting of the covering materials of Embodiments 1 to 7 will be described. The battery includes the power generation device 6000 and a covering material selected from the group consisting of the covering materials of Embodiments 1 to 7 that cover the power generation device 6000.

The area of the main surface of the power generation device 6000 may be, for example, greater than or equal to 1 cm² and less than or equal to 100 cm² when the power generation device 6000 is used in a battery for a portable electronic device such as a smartphone or a digital camera. Alternatively, the area of the main surface of the power generation device 6000 may be greater than or equal to 100 cm² and less than or equal to 1000 cm² when the power generation device 6000 is used in a battery for a power supply of large mobile equipment such as an electric vehicle.

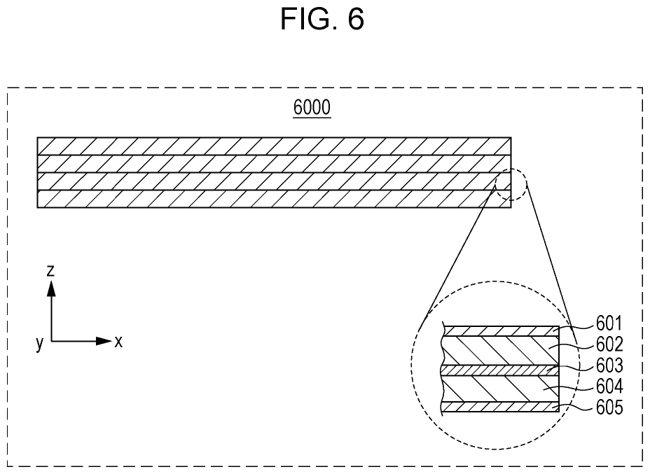

FIG. 6 is a cross-sectional view showing a schematic configuration of an example of the power generation device 6000.

The power generation device 6000 includes a positive electrode layer 602, a negative electrode layer 604, and an electrolyte layer 603.

The electrolyte layer 603 is disposed between the positive electrode layer 602 and the negative electrode layer 604. Here, the electrolyte layer 603 may be a solid electrolyte layer containing a solid electrolyte. At least one selected from the group consisting of the positive electrode layer 602, the electrolyte layer 603, and the negative electrode layer 604 contains a solid electrolyte containing halogen. The solid electrolyte containing halogen may be a halide solid electrolyte or a sulfide solid electrolyte containing halogen.

According to the configuration described above, the battery can be formed as a solid-state battery. The solid-state battery may be, for example, a storage battery such as an all-solid lithium ion secondary battery.

Further, the power generation device 6000 may further include a positive electrode current collector 601 and a negative electrode current collector 605.

The positive electrode current collector 601 is disposed in contact with the positive electrode layer 602.

Further, a part of the positive electrode current collector 601 may be exposed to the outside of the covering material 1000 as a positive electrode terminal.

The negative electrode current collector 605 is disposed in contact with the negative electrode layer 604.

Further, a part of the negative electrode current collector 605 may be exposed to the outside of the covering material 1000 as a negative electrode terminal.

As shown in FIG. 6, the power generation device 6000 may be one power generation element (unit battery cell) as described above.

For example, a porous or non-porous sheet or film made of a metal material such as aluminum, stainless steel, titanium, or an alloy thereof can be used as the positive electrode current collector 601. Aluminum and an alloy thereof are inexpensive and easy to thin. The sheet or film may be metal foil, a mesh, or the like. The thickness of the positive electrode current collector 601 may be greater than or equal to 1 μm and less than or equal to 30 μm. When the thickness of the positive electrode current collector 601 is greater than or equal to 1 μm, the mechanical strength can be sufficiently ensured. When the thickness of the positive electrode current collector 601 is less than or equal to 30 μm, the energy density of the battery can be sufficiently ensured.

The positive electrode layer 602 is a layer containing a positive electrode active material. The positive electrode layer 602 may contain a solid electrolyte. The solid electrolyte of the positive electrode layer 602 may include a solid electrolyte containing halogen. The solid electrolyte containing halogen may be a halide solid electrolyte or a sulfide solid electrolyte containing halogen.

For example, a lithium-containing transition metal oxide, a transition metal fluoride, a polyanion, a fluorinated polyanion material, a transition metal sulfide, a transition metal oxyfluoride, a transition metal oxysulfide, a transition metal oxynitride, or the like can be used as the positive electrode active material. Particularly, when a lithium-containing transition metal oxide is used as positive electrode active material particles, the production cost can be reduced, and the average discharge voltage can be increased. It is particularly preferable that Li(Ni,Co,Al)O₂ be used as the lithium-containing transition metal oxide. The energy density of the battery can be further increased when Li(Ni,Co,Al)O₂ is used.

The halide solid electrolyte is, for example, represented by Formula (1). In Formula (1), α, β, and γ each independently represent a value greater than 0. M includes at least one element selected from the group consisting of metal elements other than Li and metalloid elements. X includes at least one selected from the group consisting of F, Cl, Br, and I.

Li_{α}M_{β}X_{γ} (1)

The metalloid elements include B, Si, Ge, As, Sb, and Te. The metal elements include all elements contained in Group 1 to Group 12 in the periodic table except for hydrogen and all elements contained in Group 13 to Group 16 except for B, Si, Ge, As, Sb, Te, C, N, P, O, S, and Se. The metal elements are a group of elements that can be cations when a halogen compound and an inorganic compound are formed.

As the halide solid electrolyte, Li₃YX₆, Li₂MgX₄, Li₂FeX₄, Li(Al,Ga,In)X₄, Li₃(Al,Ga,In)X₆, or the like can be used. “(Al,Ga,In)” denotes “at least one selected from the group of consisting of Al, Ga, and In”. The representative composition of Li₃YX₆ is Li₃YBr₂Cl₄.

The thickness of the positive electrode layer 602 may be greater than or equal to 10 μm and less than or equal to 500 μm. When the thickness of the positive electrode layer 602 is greater than or equal to 10 μm, the energy density of the battery can be sufficiently ensured. When the thickness of the positive electrode layer 602 is less than or equal to 500 m, the battery can be operated at a high output.

The electrolyte layer 603 is, for example, a solid electrolyte layer containing a solid electrolyte. The solid electrolyte may be, for example, a solid electrolyte containing halogen. The solid electrolyte may contain, for example, the halide solid electrolyte described above. The solid electrolyte may contain a sulfide solid electrolyte.

For example, Li₂S—P₂S₅, Li₂S—SiS₂, Li₂S—B₂S₃, Li₂S—GeS₂, Li_{3.25}Ge_{0.25}P_{0.75}S₄, Li₁₀GeP₂Si₂, or the like can be used as the sulfide solid electrolyte. Further, LiX (X: F, Cl, Br, I), Li₂O, MO_{z}, Li_{y}MO_{z} (M: any of P, Si, Ge, B, Al, Ga, In, Fe, or Zn) (y, z: natural number), and the like may be added thereto. For example, LiX (X: F, Cl, Br, I) may be added to Li₂S—P₂S₅, Li₂S—SiS₂, Li₂S—B₂S₃, Li₂S—GeS₂, Li_{3.25}Ge_{0.25}P_{0.75}S₄, Li₁₀GeP₂S₁₂, or the like as the sulfide solid electrolyte containing halogen. Li₂S—P₂S₅ has high ionic conductivity and is unlikely to be reduced at a low potential. Therefore, a battery can be easily obtained by using Li₂S—P₂S₅.

The thickness of the electrolyte layer 603 may be greater than or equal to 1 μm and less than or equal to 100 μm. When the thickness of the electrolyte layer 603 is greater than or equal to 1 μm, the positive electrode layer 602 and the negative electrode layer 604 can be reliably insulated. Further, when the thickness of the electrolyte layer 603 is less than or equal to 100 μm, the battery can be operated at a high output.

The negative electrode layer 604 is a layer containing a negative electrode active material. The negative electrode layer 604 may contain a solid electrolyte. The solid electrolyte of the negative electrode layer 604 may contain a solid electrolyte containing halogen. The solid electrolyte containing halogen may be a halide solid electrolyte or a sulfide solid electrolyte containing halogen.

The negative electrode active material may be, for example, a material that occludes and releases metal ions. The negative electrode active material may be, for example, a material that occludes and releases lithium ions. For example, lithium metal, a metal or an alloy showing an alloying reaction with lithium, carbon, a transition metal oxide, a transition metal sulfide, or the like can be used as the negative electrode active material. For example, graphite or non-graphite carbon such as hard carbon or coke is used as carbon. For example, CuO, NiO, or the like can be used as the transition metal oxide. For example, copper sulfide represented by CuS can be used as the transition metal sulfide. For example, a silicon compound, a tin compound, or an alloy of an aluminum compound and lithium can be used as a metal or an alloy showing an alloying reaction with lithium. When carbon is used, the production cost can be reduced, and the average discharge voltage can be increased.

The thickness of the negative electrode layer 604 may be greater than or equal to m and less than or equal to 500 μm. When the thickness of the negative electrode layer 604 is greater than or equal to 10 μm, the energy density of the battery can be sufficiently ensured. When the thickness of the negative electrode layer 604 is less than or equal to 500 μm, the battery can be operated at a high output.

For example, a porous or non-porous sheet or film made of a metal material such as stainless steel, nickel, copper, or an alloy thereof can be used as the negative electrode current collector 605. Copper and an alloy thereof are inexpensive and easy to thin. The sheet or film may be metal foil or a mesh. The thickness of the negative electrode current collector 605 may be greater than or equal to 1 μm and less than or equal to 30 μm. When the thickness of the negative electrode current collector 605 is greater than or equal to 1 μm, the mechanical strength can be sufficiently ensured. When the thickness of the negative electrode current collector 605 is less than or equal to 30 μm, the energy density of the battery can be sufficiently ensured.

At least one of the positive electrode layer 602, the electrolyte layer 603, or the negative electrode layer 604 may contain an oxide solid electrolyte for the purpose of increasing the ionic conductivity. As the oxide solid electrolyte, LiTi₂(PO₄)₃ and a NASICON type solid electrolyte representing an element substitute thereof, a (LaLi)TiO₃-based perovskite type solid electrolyte, Li₁₄ZnGe₄O₁₆, Li₄SiO₄, LiGeO₄ and a LISICON type solid electrolyte representing an element substitute thereof, Li₇La₃Zr₂O₁₂ and a garnet type solid electrolyte representing an element substitute thereof, Li₃N and an H-substitute thereof, Li₃PO₄, and an N-substitute thereof can be used.

At least one of the positive electrode layer 602, the electrolyte layer 603, or the negative electrode layer 604 may contain an organic polymer solid electrolyte for the purpose of increasing the ionic conductivity. For example, a compound of a polymer compound with a lithium salt can be used as the organic polymer solid electrolyte. The polymer compound may have an ethylene oxide bond. When the polymer compound has an ethylene oxide bond, the polymer compound can contain a large amount of lithium salts, and the ionic conductivity can be further increased. As the lithium salt, LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), LiC(SO₂CF₃)₃, or the like can be used. One type of lithium salt selected from these can be used alone as the lithium salt. Alternatively, a mixture of two or more kinds of lithium salts selected from these can be used as the lithium salt.

At least one of the positive electrode layer 602, the electrolyte layer 603, or the negative electrode layer 604 may contain a non-aqueous electrolyte solution, a gel electrolyte, and an ionic liquid for the purpose of facilitating transfer of lithium ions and improving output characteristics of the battery. The non-aqueous electrolyte solution contains a non-aqueous solvent and a lithium salt dissolved in a non-aqueous solvent. A cyclic carbonic acid ester solvent, a chain carbonic acid ester solvent, a cyclic ether solvent, a chain ether solvent, a cyclic ester solvent, a chain ester solvent, a fluorine solvent, or the like can be used as the non-aqueous solvent. Examples of the cyclic carbonic acid ester solvent include ethylene carbonate, propylene carbonate, and butylene carbonate. Examples of the chain carbonic acid ester solvent include dimethyl carbonate, ethyl methyl carbonate, and diethyl carbonate. Examples of the cyclic ether solvent include tetrahydrofuran, 1,4-dioxane, and 1,3-dioxolane. Examples of the chain ether solvent include 1,2-dimethoxyethane and 1,2-diethoxyethane. Examples of the cyclic ester solvent include γ-butyrolactone. Examples of the chain ester solvent include methyl acetate. Examples of the fluorine solvent include fluoroethylene carbonate, methyl fluoropropionate, fluorobenzene, fluoroethyl methyl carbonate, and fluorodimethylene carbonate. One kind of non-aqueous solvent selected from these can be used alone as the non-aqueous solvent. Alternatively, two or more kinds of non-aqueous solvents selected from these can be used in combination as the non-aqueous solvent. The non-aqueous electrolyte solution may contain at least one fluorine solvent selected from the group consisting of fluoroethylene carbonate, methyl fluoropropionate, fluorobenzene, fluoroethyl methyl carbonate, and fluorodimethylene carbonate. As the lithium salt, LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), LiC(SO₂CF₃)₃, or the like can be used. One type of lithium salt selected from these can be used alone as the lithium salt. Alternatively, a mixture of two or more kinds of lithium salts selected from these can be used as the lithium salt. The concentration of the lithium salt is, for example, in a range of greater than or equal to 0.5 mol/L and less than or equal to 2 mol/L.

A polymer material containing a non-aqueous electrolyte solution can be used as the gel electrolyte. As the polymer material, polyethylene oxide, polyacrylonitrile, polyvinylidene fluoride, polymethyl methacrylate, a polymer having an ethylene oxide bond, or the like may be used.

Cations constituting the ionic liquid may be aliphatic chain quaternary salts such as tetraalkyl ammonium and tetraalkyl phosphonium, aliphatic cyclic ammonium such as pyrrolidiniums, morpholiniums, imidazoliniums, tetrahydropyrimidiniums, piperaziniums, and piperidiniums, nitrogen-containing heterocyclic aromatic cations such as pyridiniums and imidazoliums, or the like. Anions constituting the ionic liquid may be PF₆⁻, BF4⁻, SbF₆⁻, AsF₆⁻, SO₃CF₃⁻, N(SO₂CF₃)₂⁻, N(SO₂C₂F₅)₂⁻, N(SO₂CF₃)(SO₂C₄F₉)⁻, C(SO₂CF₃)₃⁻, or the like. Further, the ionic liquid may contain a lithium salt.

At least one of the positive electrode layer 602, the electrolyte layer 603, or the negative electrode layer 604 may contain a binder for the purpose of improving the adhesiveness between the particles. The binder is used for improving the binding properties of the material constituting an electrode. Examples of the binder include polyvinylidene fluoride, polytetrafluoroethylene, polyethylene, polypropylene, an aramid resin, polyamide, polyimide, polyamide imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyether sulfone, hexafluoropolypropylene, styrene butadiene rubber, and carboxymethyl cellulose. Further, a copolymer of two or more kinds of materials selected from tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene can be used as the binder. Further, two or more kinds of materials selected from these may be mixed and used as the binder.

At least one of the positive electrode layer 602 or the negative electrode layer 604 may contain a conductive additive for the purpose of increasing the electronic conductivity. For example, graphites such as natural graphite and artificial graphite, carbon blacks such as acetylene black and ketjen black, conductive fibers such as carbon fibers and metal fibers, metal powders such as carbon fluoride and aluminum, conductive whiskers such as zinc oxide and potassium titanate, a conductive metal oxide such as titanium oxide, a conductive polymer compound such as polyaniline, polypyrrole, or polythiophene, or the like can be used as a conductive additive. When a carbon conductive additive is used, the costs can be reduced.

As another example, the power generation device 6000 may be formed by laminating a plurality of power generation elements.

A plurality of power generation elements may be connected, for example, in series. The voltage of the battery can be improved by connecting a plurality of power generation elements in series. Alternatively, a plurality of power generation elements may be connected, for example, in parallel. The battery capacity can be improved by connecting a plurality of power generation elements in parallel. The number of power generation elements to be connected and the connection method thereof can be appropriately selected depending on the applications of the battery.

The power generation device 6000 may be formed such that power generation elements are bipolar-laminated in series. The bipolar lamination is carried out by connecting a positive electrode layer with a negative electrode layer of a power generation element adjacent to the positive electrode layer using a single bipolar current collector that has functions of both the positive electrode current collector and the negative electrode current collector. When a bipolar current collector is used, the volume of the current collector in the battery can be reduced, and the energy density of the battery can be increased.

The space between the covering material 1000 and lead-out portions of the positive electrode terminal and the negative electrode terminal may be sealed with a resin or the like.

The battery according to the present disclosure can be used, for example, as an all-solid lithium ion secondary battery.

What is claimed is:

1. A battery comprising:
a power generator; and
a covering material that covers the power generator, wherein
the power generator includes
a positive electrode layer,
a negative electrode layer, and
a solid electrolyte layer positioned between the positive electrode layer and the negative electrode layer,
at least one selected from the group consisting of the positive electrode layer, the solid electrolyte layer, and the negative electrode layer contains a solid electrolyte containing halogen,
the covering material includes
a base layer,
a resin layer, and
an interlayer positioned between the base layer and the resin layer, and
the resin layer is disposed on a side facing the power generator and contains a halogen-containing polymer.

2. The battery according to claim 1, wherein
the covering material further includes a metal layer positioned between the base layer and the interlayer.

3. The battery according to claim 2, wherein
the metal layer contains at least one selected from the group consisting of aluminum, an aluminum alloy, and stainless steel.

4. The battery according to claim 2, wherein
the metal layer contains aluminum.

5. The battery according to claim 1, wherein
an ionic radius of halogen contained in the resin layer is same as or less than an ionic radius of the halogen contained in the solid electrolyte.

6. The battery according to claim 1, wherein
the resin layer has a thickness less than a thickness of the interlayer.

7. The battery according to claim 1, wherein
the resin layer has a variation in thickness depending on a site.

8. The battery according to claim 1, wherein
the covering material includes a first covering material and a second covering material,
the resin layer includes a first resin layer and a second resin layer,
the interlayer includes a first interlayer and a second interlayer, and
a portion where the first covering material and the second covering material face each other includes a portion where the first interlayer and the second interlayer are in contact with each other.

9. The battery according to claim 1, wherein
the interlayer contains a filler and an other material other than the filler, and
the filler includes a filler having a softening point higher than a softening point of the other material.

10. The battery according to claim 9, wherein
the filler has a melting point higher than a melting point of the halogen-containing polymer.

11. The battery according to claim 1, wherein
the resin layer has a pore.

12. The battery according to claim 1, wherein
the halogen-containing polymer is a polymer containing a fluorine atom or a chlorine atom.

13. The battery according to claim 12, wherein
the halogen-containing polymer is a polymer containing fluorine, and
the polymer containing fluorine contains at least one selected from the group consisting of tetrafluoroethylene, vinylidene fluoride, perfluoroalkyl vinyl ether, hexafluoropropylene, chlorotrifluoroethylene, and copolymers thereof.

14. The battery according to claim 12, wherein
the halogen-containing polymer is a polymer containing fluorine, and
the polymer containing fluorine contains at least one selected from the group consisting of tetrafluoroethylene, vinylidene fluoride, hexafluoropropylene, and copolymers thereof.

15. The battery according to claim 12, wherein
the halogen-containing polymer is a polymer containing fluorine, and
the polymer containing fluorine contains at least one selected from the group consisting of polyethylene fluoride, polypropylene fluoride, a tetrafluoroethylene-hexafluoropropylene copolymer, polytetrafluoroethylene, polyvinylidene fluoride, polyvinyl fluoride, polychlorotrifluoroethylene, fluororubber, fluorosilicone rubber, a vinylidene fluoride-hexafluoropropylene copolymer, a vinylidene fluoride-hexafluoropropylene-tetrafluoroethylene copolymer, tetrafluoroethylene-propylene rubber, and tetrafluoroethylene-perfluoromethyl vinyl ether rubber.

16. The battery according to claim 1, wherein
a concentration of halogen of the resin layer increases continuously or stepwisely from a side facing the interlayer to a side facing away from the interlayer.

17. A covering material for a battery, comprising:
a base layer;
a resin layer; and
an interlayer positioned between the base layer and the resin layer, wherein
the resin layer contains a halogen-containing polymer.

18. The covering material for a battery according to claim 17, further comprising a metal layer positioned between the base layer and the interlayer.

19. The covering material for a battery according to claim 18, wherein
the metal layer contains aluminum.

20. The covering material for a battery according to claim 17, wherein
the halogen-containing polymer is a polymer containing a fluorine atom or a chlorine atom.

21. The covering material for a battery according to claim 20, wherein
the halogen-containing polymer is a polymer containing fluorine, and
the polymer containing fluorine contains at least one selected from the group consisting of tetrafluoroethylene, vinylidene fluoride, perfluoroalkyl vinyl ether, hexafluoropropylene, and chlorotrifluoroethylene.

22. The covering material for a battery according to claim 20, wherein
the halogen-containing polymer is a polymer containing fluorine, and
the polymer containing fluorine contains at least one selected from the group consisting of tetrafluoroethylene, vinylidene fluoride, and hexafluoropropylene.

23. The covering material for a battery according to claim 20, wherein
the halogen-containing polymer is a polymer containing fluorine, and
the polymer containing fluorine contains at least one selected from the group consisting of polyethylene fluoride, polypropylene fluoride, a tetrafluoroethylene-hexafluoropropylene copolymer, polytetrafluoroethylene, polyvinylidene fluoride, polyvinyl fluoride, polychlorotrifluoroethylene, fluorosilicone rubber, a vinylidene fluoride-hexafluoropropylene copolymer, a vinylidene fluoride-hexafluoropropylene-tetrafluoroethylene copolymer, tetrafluoroethylene-propylene rubber, and tetrafluoroethylene-perfluoromethyl vinyl ether rubber.
